(19) United States
(12) Patent Application Publication
(10) Pub. No.: US 2020/0011696 A1
(43) Pub. Date: Jan. 9, 2020

(54) INDOOR WAYFINDING TO EQUIPMENT AND INFRASTRUCTURE

(71) Applicant: Honeywell International Inc., Morris Plains, NJ (US)

(72) Inventors: Arun Vijayakumari Mahasenan, Hopkins, MN (US); Aravind Padmanabhan, Plymouth, MN (US); Samuel George Fenton, Glenwood (AU)

(21) Appl. No.: 16/026,939

(22) Filed: Jul. 3, 2018

(51) Int. Cl. G01C 21/36; G06F 17/30; G06F 7/14; G06T 11/60; H04W 4/024; H04W 4/33; G01C 21/20

(52) U.S. Cl. CPC G01C 21/3647; G06F 17/30241; G06F 7/14; G06T 11/60; G06T 2200/24; H04W 4/33; G01C 21/206; G01C 21/3697; H04W 4/024

(57) ABSTRACT

Methods, systems, and devices for indoor wayfinding to equipment and infrastructure at a facility are described herein. One method includes receiving an identifier associated with a piece of equipment or infrastructure within a facility, receiving location information associated with the location of the piece of equipment or infrastructure within the facility, receiving visual view data to produce a visual view of an area of the facility, and merging the identifier, the location information, and the visual view data to produce a visual view on a user interface of a computing device to communicate the location of the piece of equipment or infrastructure to a user of the computing device.

### TECHNICAL FIELD

The present disclosure relates generally to indoor wayfinding to equipment and infrastructure at a facility.

### BACKGROUND

The equipment and infrastructure of a facility, such as that of a building, industrial space, manufacturing plant, warehouse, air liner, or cruise ship, can, in many cases, be purposefully hidden from view from occupants of the facility. This can be done for a variety of reasons. For example, components can be hidden to improve the aesthetics of the facility, to keep such components from being tampered with, and/or to minimize sounds from such components in spaces where occupants are present.

However, with these components hidden, it can be difficult for them to be located. For example, an HVAC service technician that is coming to the facility to perform service or diagnose a problem may need to access one or more boilers, heat pumps, vents, fans, duct work, etc. without being able to see the equipment or infrastructure because it is hidden behind a wall, hidden behind a false ceiling, or in a specialized space dedicated to such equipment or infrastructure.

Additionally, in some facilities there many be many of the same type of devices in close proximity (e.g., smoke detectors in a cafeteria. In such instances, it may be difficult to determine which detector was tripped based on an audible signal. Or, if providing service on the devices, it may be difficult to track which devices have been serviced and which have not. These issues can make service work or emergency response inefficient as the correct devices cannot be easily located.

### BRIEF DESCRIPTION OF THE DRAWINGS

FIG. 1 illustrates an example of a system for providing a wayfinding functionality in a facility in accordance with an embodiment of the present disclosure.

FIG. 2 illustrates an example of a network architecture for integrating functionality in an existing sensor device of a facility in accordance with an embodiment of the present disclosure.

FIG. 3 illustrates an example of a sensor device of a facility having wayfinding functionality therein in accordance with an embodiment of the present disclosure.

FIG. 4 illustrates an example of a computing device for providing wayfinding functionality in a sensor device of a facility in accordance with an embodiment of the present disclosure.

FIG. 5 illustrates a screen shot of a user interface showing multiple devices near a user in accordance with an embodiment of the present disclosure.

FIG. 6 illustrates a screen shot of another view of a user interface showing multiple devices near a user in accordance with an embodiment of the present disclosure.

FIG. 7 illustrates a screen shot of a user interface presenting information about the location of a piece of equipment in the facility in accordance with an embodiment of the present disclosure.

FIG. 8 illustrates a screen shot of a user interface showing details of a selected devices in accordance with an embodiment of the present disclosure.

FIG. 9 illustrates a screen shot of a user interface showing multiple devices that are interconnected in accordance with an embodiment of the present disclosure.

FIG. 10 illustrates a screen shot of a user interface showing an overhead view of a component location on a map in accordance with an embodiment of the present disclosure.

FIG. 11 illustrates a screen shot of a user interface showing an overhead view of multiple device locations on a map in accordance with an embodiment of the present disclosure.

### DETAILED DESCRIPTION

Methods, systems, and devices for indoor wayfinding to equipment and infrastructure at a facility are described herein. For example, one method includes receiving an identifier associated with a piece of equipment or infrastructure within a facility, receiving location information associated with the location of the piece of equipment or infrastructure within the facility, receiving visual view data to produce a visual view of an area of the facility, and merging the identifier, the location information, and the visual view data to produce a visual view on a user interface of a computing device to communicate the location of the piece of equipment or infrastructure to a user of the computing device.

Accordingly, embodiments of the present disclosure can use sensor or stored data and/or a map database to determine the location of a device and direct a user to the location. For instance, embodiments of the present disclosure can be used in firefighting and facility equipment and infrastructure service, among other applications.

For example, the scope should include any building system functionality, that uses a device which is connected to a network associated with the facility. Systems can, for example, include: HVAC, fire detection, fire control, security sensing (including motion, sound, vibration, cameras, etc.), access control, and asset tracking, among others. Types of devices can include: HVAC, access control modules, fire alerting devices, fire detection devices, mass notification devices, elevators, lighting, conference room equipment, computing devices, advertising boards, ticketing machines, escalators, or other fixed or moving devices within a facility. Some examples of how such systems and devices can operate are discussed in more detail below.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

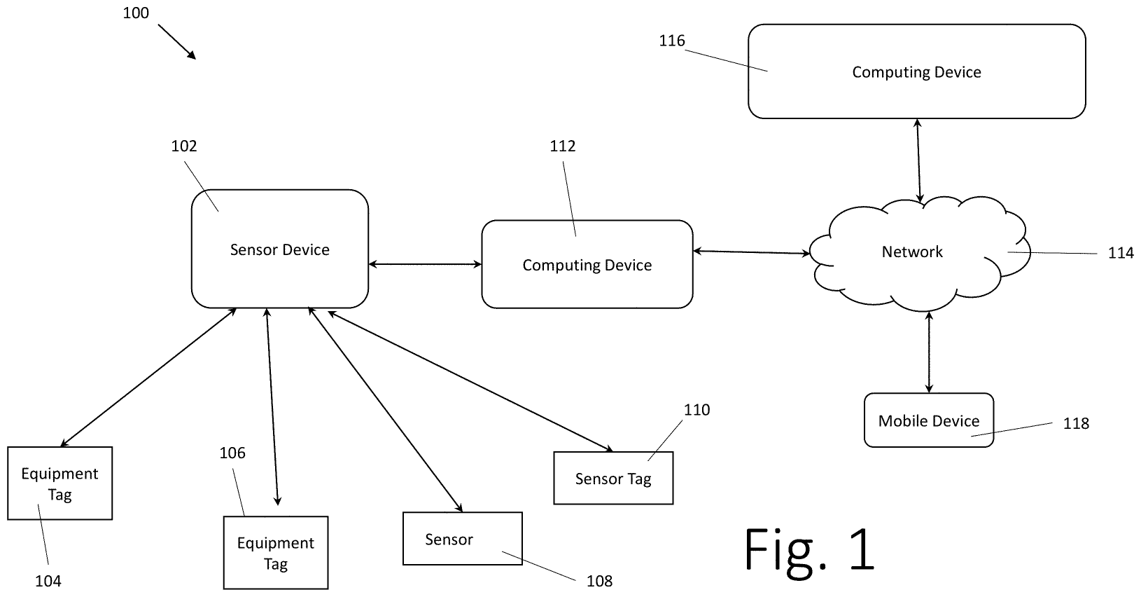

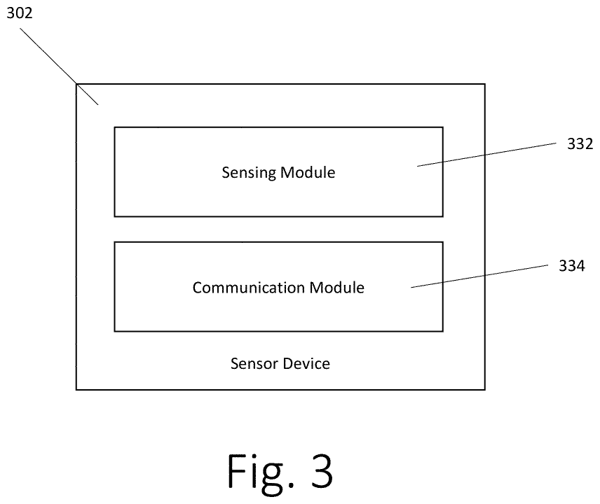

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 302 in FIG. 3.

As used herein, “a” or “a number of” something can refer to one or more such things, while “a plurality of” something can refer to more than one such things. For example, “a number of sensor devices” can refer to one or more sensor devices, while “a plurality of sensor devices” can refer to more than one sensor device.

FIG. 1 illustrates an example of a system for providing a wayfinding functionality in a facility in accordance with an embodiment of the present disclosure. The facility can be, for example, an indoor space such as a building, industrial space, manufacturing plant, warehouse, factory, mining facility, agricultural facility, parking garage or ramp, health care facility (e.g., hospital), airport, retail facility (e.g., shopping complex) or hotel, among other types of facilities and/or indoor spaces. However, embodiments of the present disclosure are not limited to a particular facility or facility type.

In some embodiments, an identifier can be associated with a piece of equipment or infrastructure. This can be accomplished by placing the sensor tag on or near the equipment or infrastructure component to be identified. This can be beneficial in already installed systems within a facility as the sensor tags can be installed after the system is in place. An identifier can also be associated by having identifier information integrated in the component, for example, at the time the component is manufactured.

As used herein, equipment is any device within that provides a function to the facility that may need to be located or serviced. For example, this may be needed by emergency response personnel or in requiring service from technicians. Infrastructure is other components that allow the equipment to function properly, such as valves, ducts, control panels, etc.

In the embodiment of FIG. 1, sensor device 102 can be any type of device (e.g., a hardware device) having the capability of (e.g., embedded software capable of) measuring and/or detecting data (e.g., temperature, pressure, humidity, light, motion, sound, carbon air quality, vibration, etc.) For example, sensor device 102 can be, a fire and/or smoke detector, a wall module (e.g., thermostat), a temperature and/or humidity sensor, a light sensor, a component of a public address/voice alarm (PA/VA) system (e.g., a speaker), an alarm (e.g., a strobe), a component of a mass notification system, signage (e.g., a signage display), a camera, a security sensor, an electronic lock, and/or an HVAC sensor and/or equipment, among others. However, embodiments of the present disclosure are not limited to a particular sensor device or type of sensor device.

Sensor device 102 can be part of the existing infrastructure (e.g., the existing lighting, fire, security, and/or HVAC infrastructure) of the facility. For example, sensor device 102 may be installed (e.g., deployed) in the existing infrastructure of the facility in accordance with the applicable safety (e.g., UL) codes, and may be line powered from a loop circuit.

Although one (e.g., a single) sensor device 102 is illustrated in FIG. 1 for simplicity and so as not to obscure embodiments of the present disclosure, embodiments are not so limited. For example, system 100 can include any number of sensor devices analogous to sensor device 102, which may be collectively referred to as sensor device 102.

For example, as shown in FIG. 1, system 100 can include equipment (e.g., asset) tags 104 and 106. Equipment tags 104 and 106 can be, for instance, a tag (e.g., badge) attached or coupled to an item of equipment in the facility.

Sensor device 102 can obtain (e.g., receive) an identifier and/or location data from equipment tags 104 and/or 106. The location data received from equipment tags 104 and/or 106 can indicate the current location of the item of equipment or infrastructure in the facility, respectively.

Sensor device 102 can receive the location data from equipment tags 104 and/or 106 via a first type of wireless communication. For example, sensor device 102 can receive the location data from equipment tag 104 via sub gigahertz (e.g., 900 megahertz) signals transmitted from equipment tag 104. These signals could also come via Bluetooth (e.g., BLE) or Wi-Fi signals, among other suitable communication formats.

Sensor device 102 can receive the location data from a number of locations including from a computing device in communication with the sensor device via the network connection or via equipment tags 104 and/or 106 using a communication module (e.g., a radio communication module), for example. For instance, the communication module can include a signal receiver that can receive the location data from equipment tags 104 and/or 106.

Sensor device 102 may obtain the sensed data by, for example, directly sensing the data using the sensing module or mechanism integrated in sensor device 102. As an additional example, sensor device 102 may receive the sensed data from sensor tags 108 and 110 illustrated in FIG. 1.

Sensor tags 108 and 110 can be, for instance, an ultrasound sensor tag and an infrared sensor tag, respectively, located in the facility. Sensor device 102 can receive the sensed data from sensor tags 108 and 110 via wireless communication (e.g., via sub gigahertz signals transmitted by sensor tags 108 and 110) using the communication module (e.g., the signal receiver of the communication module).

Location data, and other equipment and infrastructure information, can be stored in one or more computing devices (e.g., devices 112 and 116). For example, this information can be stored in one or more data stores in memory on the computing device or a building information model can be stored on the device and the information can be contained in data stores related to that model.

In such embodiments, it may be necessary to convert the location data from the format in which it is stored for purposes of the building information model to its use in the visual view of embodiments of the present disclosure. For example, the location information maybe be presented in different coordinate systems, different Cartesian coordinate systems, have different offsets of origin, and/or different XY axis scaling.

For instance, the information may need to be converted from a building information model geometric object format to a vector format. Accordingly, one or more conversion algorithms may be needed to convert the location information from the building information model or other format that it has been stored in into an acceptable format for the embodiments of the present disclosure.

Upon receiving the information obtained from sensor device 102, computing device 112 can send (e.g., transmit) the information to computing device 116 via network 114 illustrated in FIG. 1. Computing device 116 can be located remotely from the facility (e.g., remotely from computing device 112). For instance, computing device 116 can be part of a centralized, cloud-based analytics service (e.g., servers and/or databases).

Network 114 can be a wired or wireless network. For example, network 114 can be a network relationship through which computing devices 112 and 116 can communicate. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive the information from computing device 112 and transmit the anomalous audio portion to computing device 116 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

Computing device 116 can use the information received from computing device 112 (e.g., the information obtained by sensor device 102) to provide software-based services for the facility. For example, computing device can use the information to run (e.g., address, enable, and/or operate) multiple facility management apps, such as, for instance, communication, sensing (e.g., space, environment, air quality, and/or noise sensing), location (e.g., real time location service and/or wayfinding), occupancy, equipment (e.g., asset) tracking, comfort control, energy management, fire and safety, fire system, security management, HVAC control, space utilization, labor productivity, and/or environmental monitoring applications.

In various embodiments, computing device 116 can use the information to run such applications as mobile apps on mobile device 118 via network 114 illustrated in FIG. 1. Mobile device 118 can be, for example, the mobile device (e.g., smart phone, tablet, smart wearable device, etc.) of, for example, an owner, manager, technician, security personnel, emergency personnel, tenant, worker, or guest of the facility, depending upon the application being utilized.

As an example, a location services application can use the information obtained by sensor device 102 to locate equipment (e.g., assets) in a facility, control HVAC equipment and lighting to achieve energy efficiency, and/or provide automatic navigation inside the facility for humans and/or machines such as wheel chair navigation to a destination or robots for building automation activities such as cleaning or delivery, among other uses.

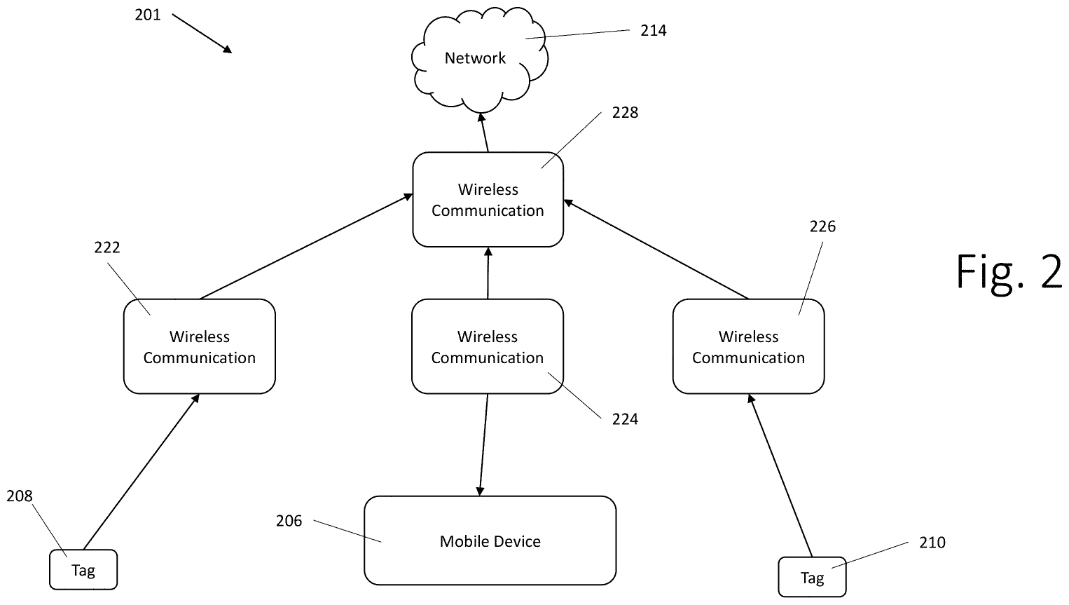

FIG. 2 illustrates an example of a network architecture 201 for integrating functionality in a sensor device of a facility in accordance with an embodiment of the present disclosure. The sensor device can be, for example, sensor device 102 previously described in connection with FIG. 1

As shown in FIG. 2, data (e.g., location data) can be communicated (e.g., sent) from mobile device 206 to the sensor device via wireless communication 224. Mobile device 206 can be, for example, mobile device 106 previously described in connection with FIG. 1. Wireless communication 224 can include, for example, Bluetooth (e.g., BLE) and/or Wi-Fi communication, as previously described in connection with FIG. 1.

As shown in FIG. 2, data (e.g., sensed data) can be communicated from sensor tags 208 and 210 to the sensor device via wireless communication 222 and 226, respectively. Sensor tags 208 and 210 can be, for example, sensor tags 108 and 110, respectively, previously described in connection with FIG. 1. Wireless communication 222 and 226 can include, for example, sub gigahertz (e.g., 900 megahertz) communication, as previously described in connection with FIG. 1.

The data communicated from mobile device 206 and sensor tags 208 and 210 to the sensor device can then be communicated from the sensor device to a computing device via wireless communication 228 illustrated in FIG. 2. The computing device may be, for example, computing device 112 previously described in connection with FIG. 1. Wireless communication 228 can include, for example, Bluetooth or PoE communication, as previously described in connection with FIG. 1.

The data can then be communicated from the computing device to an additional computing device via network 214 illustrated in FIG. 2. The additional computing device can be, for example, computing device 116 previously described in connection with FIG. 1. Network 214 van be, for example, network 114 previously described in connection with FIG. 1.

FIG. 3 illustrates an example of a sensor device 302 of a facility having functionality integrated therein in accordance with an embodiment of the present disclosure. Sensor device 302 can be, for example, sensor device 102 previously described in connection with FIG. 1.

As shown in FIG. 3, sensor device 302 can include a sensing module 332 and a communication module 334. Sensing and communication modules 332 and 334 can be used for sensing conditions in an area and/or to identify location of sensor 302, as previously described in connection with FIG. 1.

Sensing module 332 may be used by sensor device 302 to sense data, as previously described in connection with FIG. 1. Further, communication module 334 may be used by sensor device 302 to receive and send information, as previously discussed in connection with FIG. 1. For example, communication module 334 can be a radio communication module, and can include a signal receiver and signal transmitter that can send and receive, respectively, as previously described in connection with FIG. 1.

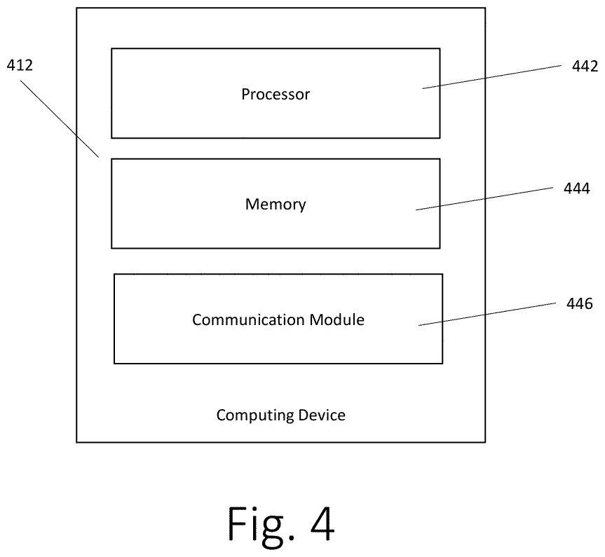

FIG. 4 illustrates an example of a computing device 412 for integrating functionality in a sensor device of a facility in accordance with an embodiment of the present disclosure. Computing device 412 can be, for example, computing device 112 previously described in connection with FIG. 1.

Computing device 412 can be, for example, a laptop computer, a desktop computer, or a mobile device. However, embodiments of the present disclosure are not limited to a particular type of computing device.

As shown in FIG. 4, computing device 412 can include a processor 442 and a memory 444. Memory 444 can be any type of storage medium that can be accessed by processor 442 to perform various examples of the present disclosure.

For example, memory 444 can be a non-transitory computer readable medium having computer readable instructions (e.g., computer program instructions) stored thereon that are executable by processor 442 to perform various examples of the present disclosure. That is, processor 442 can execute the executable instructions stored in memory 444 to perform various examples of the present disclosure.

Memory 444 can be volatile or nonvolatile memory. Memory 444 can also be removable (e.g., portable) memory, or non-removable (e.g., internal) memory. For example, memory 444 can be random access memory (RAM) (e.g., dynamic random access memory (DRAM), resistive random access memory (RRAM), and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 444 is illustrated as being located in computing device 412, embodiments of the present disclosure are not so limited. For example, memory 444 can also be located internal to another computing resource (e.g., enabling computer readable instructions to be downloaded over the Internet or another wired or wireless connection).

Further, a communication module 446 may be used by computing device 412 to receive and send information, as previously discussed in connection with FIG. 1. For example, communication module 446 can be a radio communication module, and can include a signal receiver and signal transmitter that can send and receive, respectively, as previously described in connection with FIG. 1.

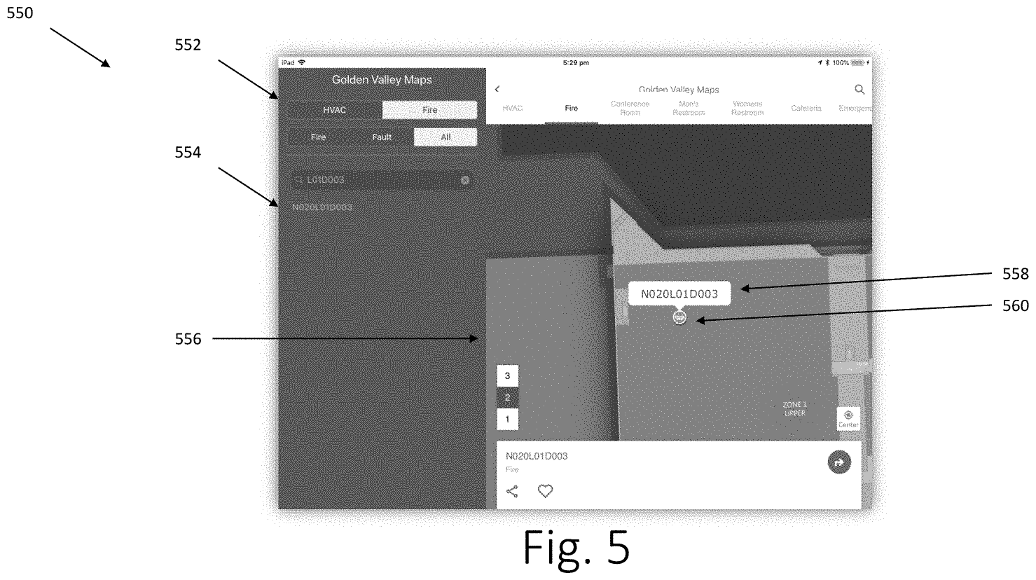

FIG. 5 illustrates a screen shot of a user interface showing multiple devices near a user in accordance with an embodiment of the present disclosure. In this embodiment, a user interface is provided on a user device (e.g., mobile device 118 of FIG. 1). As can be seen in FIGS. 5-11 herein, the user interface can have several configurations and can provide a variety of information that can be helpful for the user.

In the implementation shown in FIG. 5, user interface 550 has an area for defining what is being viewed (e.g., left side) and a viewing area (e.g., right side). On the top of the left side, the user has a choice area 552 where the user can select the type of data that is shown on the user interface.

In FIG. 5, two choices are shown, HVAC and Fire, however, any number of choices could be available in the choice area and as discussed herein, the choices available can be for many different functions within the facility. In this example, the user has selected the fire functionality to observe at 552.

The user has also defined the area to be viewed by scaling the map shown at 556. In some embodiments, the user interface can suggest a viewing area for the user to view, for example, based on the selection made in 552.

In this example, the selection made in the choice area 552 of the fire system to view in the user interface results in the identification of a device 554 listed by its unique identifier in a system component list area 554. The identifier can be any suitable identifier and can be assigned by the user interface or can be an identifier that is already associated with the system component. As used herein, a system component is a piece of equipment or infrastructure of the facility that is part of a system of pieces of equipment or infrastructure that interact as a system to provide a particular functionality within the facility).

On the map, the location of the system component is shown at 560 and is identified by its identifier 558 which corresponds to the identifier in the list 554. The providing of the identifier can aid the user in finding the correct component, among other benefits.

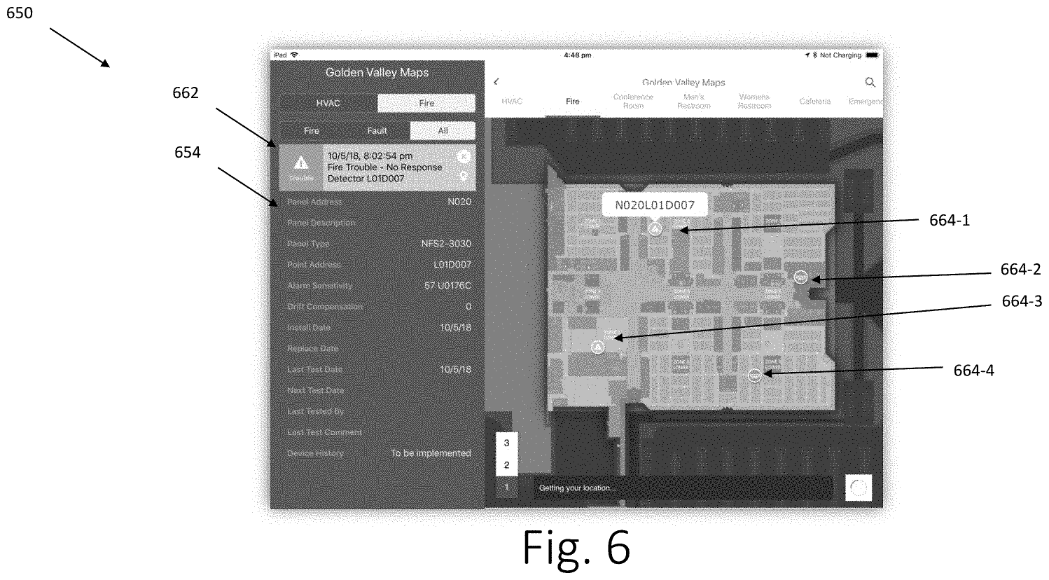

FIG. 6 illustrates a screen shot of another view of a user interface showing multiple devices near a user in accordance with an embodiment of the present disclosure. In FIG. 6, the map on the user interface 650 has been expanded to show a larger area of the facility and the view now includes several system components 664-1, 664-2, 664-3, 664-4. One of the components, 664-1 is indicating a fire condition that should be investigated.

The area shown in the map can be configured by the user, can be preset by the executable instructions that provide the user interface, or can be defined by executable instructions based on an analysis of the sensor data provided by the system components to identify where an issue (e.g., fire condition) may be present within the facility.

Information about the fire condition is shown at 662. This can contain any information that would be useful to the user in determining what to do with respect to this condition (e.g., send someone to investigate, check sensor status, reset the sensor or system, contact emergency response personnel).

Area 654 provides information about component 664-1, so that the user can better understand what fire condition information is being provided. The information can be anything that would be helpful to the user to understand the fire condition information better (e.g., component identifier, group identifier that this component belongs to, a location identifier, component type (e.g., smoke sensor, heat sensor, audible alarm, visual alarm), installation date, last test date, technician identifier (name, badge number), technician notes, component history, etc.).

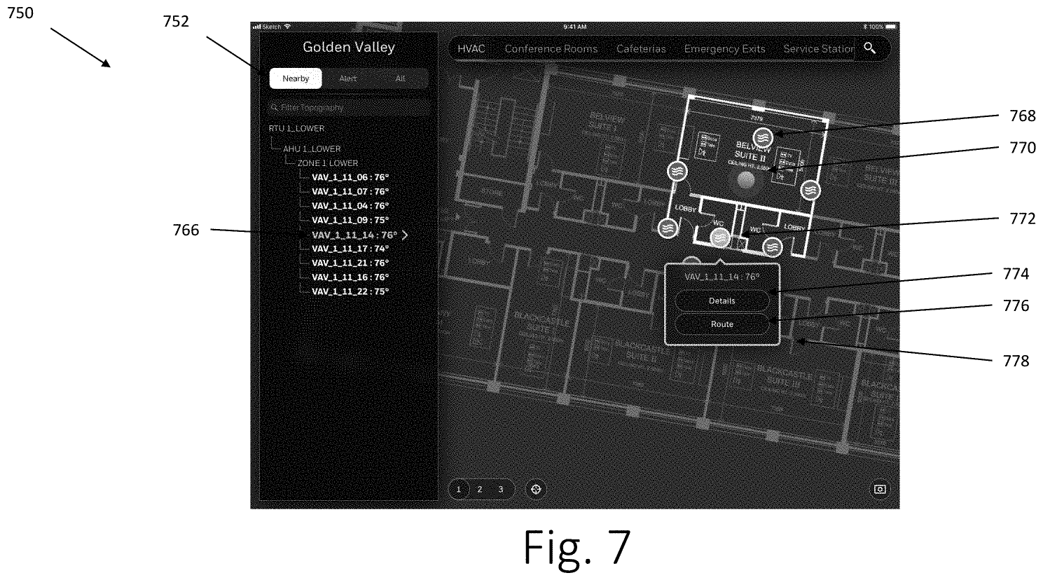

FIG. 7 illustrates a screen shot of a user interface presenting information about the location of a piece of equipment in the facility in accordance with an embodiment of the present disclosure. In the embodiment shown in FIG. 7, the map shows an area around the location of the user. In some embodiments, the executable instructions providing the user interface can determine the position of the user (based on sensor data from their user device) and can orient their position on the map (based on visual view data that includes map structural details of the facility and locations of such structures that can be merged with the location data of the user to therefore provide a visual view of the user's location within the facility.

In the embodiment of FIG. 7, the user interface 750 shows that the user has selected to see nearby system components at choice area 752. In some embodiments, the user can choose to see all components having alerts or all components, among other choices that may be available to the user.

Since the nearby components selection was made, the executable instructions define a viewing area to display around the location of the user at 770 and display the components (e.g., 768 shows one such component) within that area. The list area on the bottom of the left side lists all of the components in the area shown on the map. In some embodiments, the components shown may be from more than one system (e.g., all pieces of equipment and infrastructure that have identifiers).

In the embodiment of FIG. 7, a component has been selected and is identified both in the list area at 766 and on the map at 772. When selected, information about the selected component can be provided, for example, at 778. In the embodiment of FIG. 7, an information box is created when a selection of a component is made.

The information provided in this example includes the component identifier, a sensor reading that may indicate the status of the component and/or location of the component (e.g., Temperature sensor reading of 225 degrees may indicate a faulty sensor or that a fire is present. Corroboration with other nearby sensors can confirm a fire condition.). The information box 778 also includes a button for the user to select to see more details about the component at 774 (which will be discussed in more detail below) and a button at 776 to initiate and determine a route and to see a route from the user's location to the location of the component.

The route can be calculated, for example, by determining the location of the user and the component and also the structures of the facility (e.g., walls) that may be in the way of a straight line route can be considered and the route can be adjusted accordingly. For example, the route can follow hallways within the facility that may not take the user in a straight line to the component.

In some implementations, the user's position with the facility can be updated, for example, based on sensor location data from the user's device. This updated information can then be used to update the location of the user on the map view. In some embodiments the updating can be done such that the location of the user on the map is current or nearly current with the actual location of the user device.

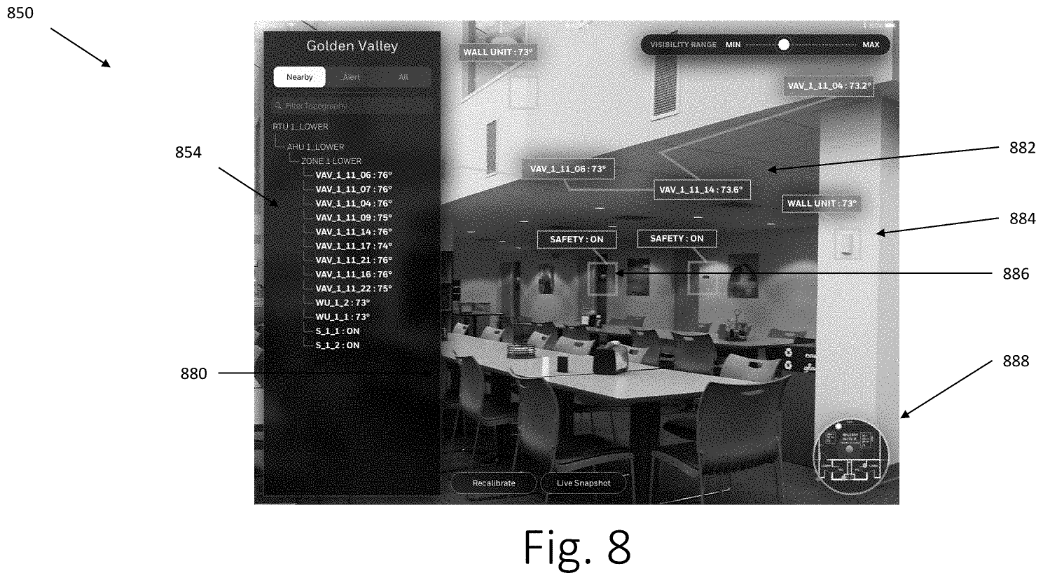

FIG. 8 illustrates a screen shot of a user interface showing details of a selected devices in accordance with an embodiment of the present disclosure. In the embodiment of FIG. 8, the user interface 850 is configured to show an image of the area at 880 rather than a map, as shown in previous implementations. This type of image can be created based on visual view data that has been taken previously and stored in a data store (data location in memory) or can be created from visual view data from a camera on the user's device or a camera in the area being imaged.

In the embodiment of FIG. 8, the list of components shown in the image 880 are provided on list 854. In this embodiment, sensors from different systems are shown in the image 880 and on the list 854 (i.e., thermostat wall units 884, variable air volume (VAV) units 882, and safety components 886).

Such an embodiment can be helpful, for example, for use by technicians when entering an area and looking for components that may need service or diagnosis of an issue. It can also identify components of other systems that may be causing the issue but may not be included in the component list for the system the technician is working on.

The embodiment also includes a map view at 888. This may help the user identify where in the facility the area in the image is located. In some embodiments, the map view can include the user's location.

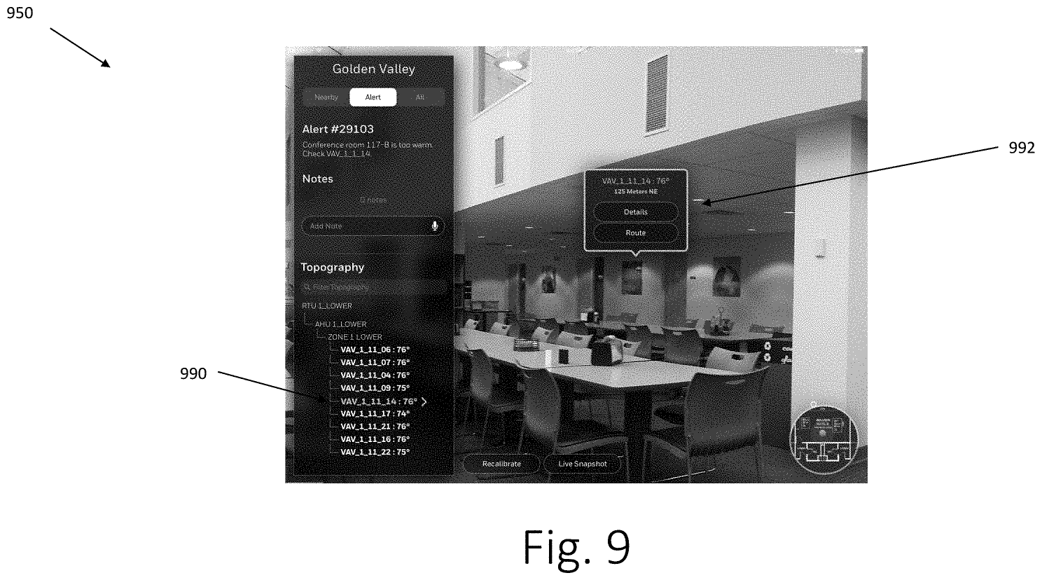

FIG. 9 illustrates a screen shot of a user interface showing multiple devices that are interconnected in accordance with an embodiment of the present disclosure. In the embodiment of FIG. 9, the user interface 950 shows that a device has been selected (component 886 of FIG. 8) with an indication in the list at 990 and with an information box being created on the image at 992.

The information box can provide any suitable information that may be of benefit to the user when viewing the image. In the embodiment shown in FIG. 9 the information provided is the component identifier, distance from the user (125 meters), direction from the user (northeast), and a temperature reading. The box also includes a details button and a route button (the image shown can be in an area remote from the user's current location).

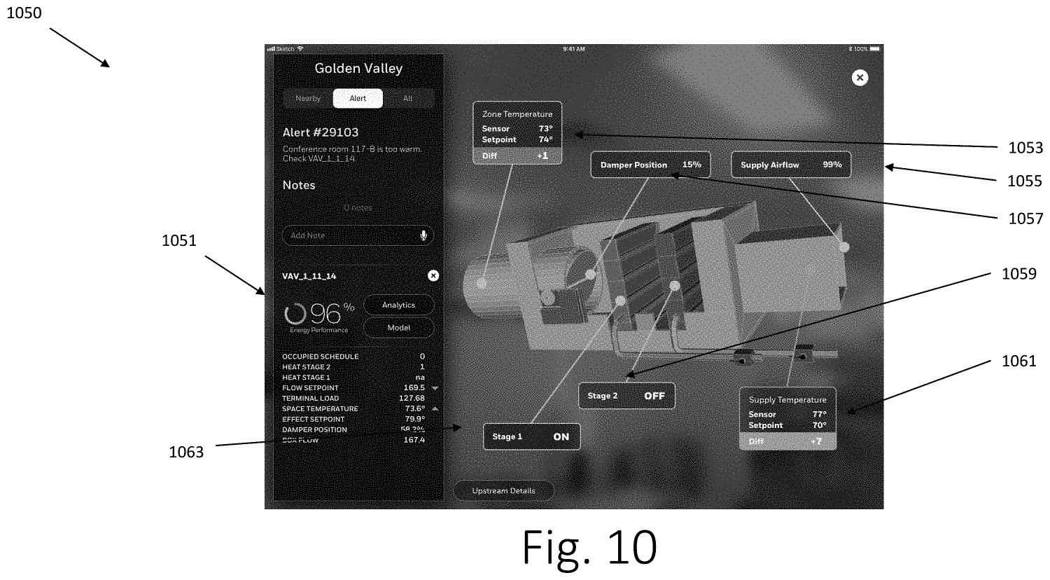

FIG. 10 illustrates a screen shot of a user interface showing an overhead view of a component location on a map in accordance with an embodiment of the present disclosure. FIG. 10 shows an example of different types of information that can be provided to the user about the device.

Although a VAV device is shown, it can be understood by the reader that the information provided in this illustration would be helpful to an operator of an HVAC system and the information provided is specialized to the needs of that functionality. Likewise, for components of other systems having other functionalities, the information provided on this type of visual view will be tailored to the needs of the operator of such a system and will be within the scope of the embodiments of this disclosure.

In FIG. 10, the user interface 1050 includes a data summary area at 1051 that provides a snapshot of the status of the component. Any suitable information that would be useful to a user can be provided in this snapshot. For example, setpoints, load status and history, sensor readings for the device, sensor readings for the location of the device (e.g., temperature in the room where the device is located or conditioning), among other information.

For the visual view, an image of the VAV device is provided. Such an image can be an image stored in memory and could be an illustration or an actual picture of the device taken by a technician and stored in memory.

In the example shown in FIG. 10, the visual view provides sensor data for various parts of the VAV device. For example, at 1053, the zone temperature information is provided including sensor reading, set point, and difference between the sensor reading and the set point. At 1055, the supply airflow value is provided as 99%, the damper position is 15% and provided at 1057.

Additionally, the stage 1 status is shown at 1063 and indicates an ON condition and the stage 2 status is shown at 1059 and indicate an OFF condition. The supply temperature is also shown at 1061 and includes a sensor temperature value, a setpoint value, and a difference value.

Such information can be beneficial, for example, to a technician who is not familiar with the device or in keeping notes about the device so that when the technician returns to the device at a later date, they can refresh their recollection of the status of the device quickly.

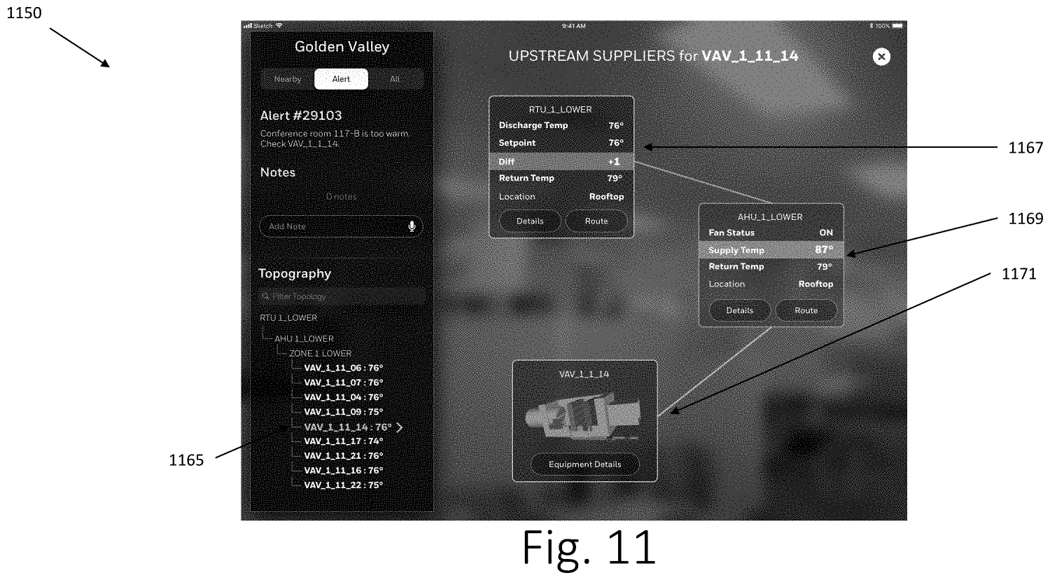

FIG. 11 illustrates a screen shot of a user interface showing an overhead view of multiple device locations on a map in accordance with an embodiment of the present disclosure. In the embodiment of FIG. 11, the user interface 1150 provides a view of multiple devices connected to a device selected for viewing by the user. In this embodiment the selected device in the list at 1165 is shown 1171 in the visual view area.

Connected devices 1167 and 1169 are shown with details of their status and data that may be helpful to diagnose an issue being indicated by device 1171. With respect to component 1167, the information provided includes the component identifier, discharge temperature value, set point value, difference value between the discharge temperature value and the set point value, return temperature value, and location of the component. The information also includes buttons to access details about this component and a button to calculate a route to the component.

With respect to component 1169 the information provided includes the component identifier, fan status, supply temperature value, return temperature value, and location. The information also includes buttons to access details about this component and a button to calculate a route to the component.

The embodiments of the present disclosure can be used in many fields of technology. For example, some fields in which this concept would be suitable include:

For building maintenance:
Electricity Meters (including sub metering)
Backup Uninterruptable Power Supplies
Gas Meters
Water Meters
Hot Water Systems
Water Pressure Sensors
Gas suppression systems (for fire control)
Water pumps (including Fire Control pumps)
Automatic Doors and Sensors
Lifts/Elevators
Doors/Revolving doors/Garage doors
Escalators
HVAC equipment
Lighting (including emergency lighting)
Parking garage sensors
Doorbells and building intercoms

For general office maintenance:
Computers
Televisions
Telephones
Photocopiers
Projectors
Printers
Network routers

For commercial buildings
Vending Machines
Ticketing Machines
Self Service Checkouts
ATMs/cash machines
Electronic advertising screens/electronic information kiosks
Security Towers (anti-theft devices at front of shops)
Kitchen appliances (stoves, ovens, dishwashers, microwaves, fridges)

For Workshops
Tools
Fabrication machinery (e.g., metal presses, computer controlled robotics, manufacturing equipment)
Cars and other vehicles
Forklifts and warehouse equipment

Provided below are several example embodiments that illustrate various aspects of the concepts of the present disclosure. A computing device embodiment can, for example, include a memory and a processor. The processor can be configured to execute executable instructions stored in the memory to: receive an identifier associated with a piece of equipment or infrastructure (e.g., identifier 558 from FIG. 5) within a facility.

The instructions can receive location information associated with the location of the piece of equipment or infrastructure within the facility. The location information can be GPS coordinates, can be based on triangulation with other devices within the facility, can be provided from a database of locations, or other suitable information to determine the location of the component.

The instructions can also receive visual view data to produce a visual view of an area of the facility. As discussed above, the visual view information can be map images stored in memory, map images created from map data stored in memory, images of areas stored in memory, images of areas taken by the user device and/or by imaging sensors, such as cameras located in the facility.

The instructions can merge the identifier, the location information, and the visual view data to produce a visual view (e.g., the right side views shown in FIGS. 5-11 are each visual views) on a user interface of the computing device to communicate the location of the piece of equipment or infrastructure to a user of the computing device.

Further, in some embodiments, the instructions include instructions to receive status information about the piece of equipment or infrastructure and merge the status information with the identifier, the location information, and the visual view data to provide the status information to a user to enable the user to see the status of the piece of equipment or infrastructure. As used herein, status information can be any information that allows the user to determine the status of the piece of equipment or infrastructure or the status of the location at which the piece of equipment or infrastructure is located.

Examples include, an indication that the component of the system is operational, that the component is on, that a valve is open, a temperature reading from a sensor, or an alarm condition, among other data from which a status can be determined. An example of status indicators that could be used with a component providing fire detection functionality include: an alarm status, a warning status, a failure status, a replacement status, a service request status, for the piece of equipment or infrastructure provides a fire detection functionality.

In some embodiments, the instructions include instructions to receive user device location information that indicates the location of a user device within the facility. This information can be merged with the identifier, the location information, and the visual view data to provide the user device location information to a user to enable the user to see their location relative to the piece of equipment or infrastructure. For example, this merged information can be used to form a visual view as described in the figures.

As described with respect to the figures herein, in some embodiments, the instructions include instructions to calculate a route from the user device location to the location of the piece of equipment or infrastructure. This route information can then be analyzed with respect to the visual view data and the visual view of the route can be provided to a user. In some cases this can be in the form of a map with the route drawn on the map, text directions provided on the visual view or elsewhere on the user interface, a distance from the component, and/or a direction to the component, for example.

The computing device can also receive functionality information about the piece of equipment or infrastructure and merge the functionality information with the identifier, the location information, and the visual view data to provide the functionality information to a user to enable the user to see what one or more functions the piece of equipment or infrastructure provides to the facility. For example, functionality information can indicate the piece of equipment or infrastructure provides an HVAC functionality or a fire detection functionality.

Further, the computing device can also receive model information about the piece of equipment or infrastructure. The model information can then be merged with the identifier, the location information, and the visual view data to provide the model information to a user. The model information can, for example, include: model brand, model type, model identification number, number of connections to other pieces of equipment and infrastructure, type of connections to other pieces of equipment and infrastructure, for the piece of equipment or infrastructure provides a fire detection functionality, among other helpful information about the model of the component that would be useful to the user.

In some embodiments, the computing device can receive connection information about the piece of equipment or infrastructure. The connection information can be merged with the identifier, the location information, and the visual view data to provide the connection information to a user to enable the user to see how the piece of equipment or infrastructure is connected to other pieces of equipment or infrastructure within the facility.

An example of such a visual view is provided in FIG. 11, wherein the connection information was used to determine the connections between components 1167, 1169, and 1171. Examples of connection information include identification information for one or more connected other pieces of equipment or infrastructure and location information, functionality information, model information, connection information, status information, service history, usage history, for one or more connected other pieces of equipment or infrastructure, among other suitable information that would be useful to the user.

An example of a system embodiment includes: a piece of equipment or infrastructure within a facility and a user device carried by a user within the facility. At least one of the piece of equipment or infrastructure or the user device includes at least one of: a first data store having an identifier associated with the piece of equipment or infrastructure, a second data store having location information associated with the location of the piece of equipment or infrastructure within the facility, a third data store having visual view data to produce a visual view of an area of the facility on a user device, and a processor to execute instructions stored in memory to: merge the identifier, the location information, and the visual view data to produce a visual view on a user interface of the computing device to communicate the location of the piece of equipment or infrastructure to a user of the computing device.

In some embodiments, the system further includes a gateway device that communicates information from the piece of equipment or infrastructure within the facility to the user device. For example, computing device 112 of FIG. 1 could potentially be a gateway device, in some embodiments. This gateway device could provide one or more functions of the described process for accomplishing embodiments of the present disclosure. For example, the gateway device can include at least one of: a first data store having an identifier associated with the piece of equipment or infrastructure, a second data store having location information associated with the location of the piece of equipment or infrastructure within the facility, a third data store having visual view data to produce a visual view of an area of the facility on a user device, and a processor to execute instructions stored in memory to: merge the identifier, the location information, and the visual view data to produce a visual view on a user interface of the computing device to communicate the location of the piece of equipment or infrastructure to a user of the computing device.

In some embodiments, the gateway device communicates the information indirectly to the user device via a network connection (e.g., network 114 of FIG. 1) through a network device (e.g., device 116). Some embodiments also a gateway device including at least one of: a first data store having an identifier associated with the piece of equipment or infrastructure, a second data store having location information associated with the location of the piece of equipment or infrastructure within the facility, a third data store having visual view data to produce a visual view of an area of the facility on a user device, and a processor to execute instructions stored in memory to: merge the identifier, the location information, and the visual view data to produce a visual view on a user interface of a computing device to communicate the location of the piece of equipment or infrastructure to a user of the computing device.

As discussed herein, the embodiments of the present disclosure can provide assistance in locating equipment and infrastructure within a facility. This can provide significant benefits to users of these embodiments as described herein.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving an identifier associated with a piece of equipment or infrastructure within a facility;
receiving location information associated with the location of the piece of equipment or infrastructure within the facility;
receiving visual view data to produce a visual view of an area of the facility; and
merging the identifier, the location information, and the visual view data to produce a visual view on a user interface of a computing device to communicate the location of the piece of equipment or infrastructure to a user of the computing device.

2. The method of claim 1, wherein the method includes receiving functionality information about the piece of equipment or infrastructure and merging the functionality information with the identifier, the location information, and the visual view data to provide the functionality information to a user to enable the user to see what one or more functions the piece of equipment or infrastructure provides to the facility.

3. The method of claim 2, wherein the functionality information indicates the piece of equipment or infrastructure provides an HVAC functionality.

4. The method of claim 2, wherein the functionality information indicates the piece of equipment or infrastructure provides a fire detection functionality.

5. The method of claim 1, wherein the method includes receiving model information about the piece of equipment or infrastructure and merging the model information with the identifier, the location information, and the visual view data to provide the model information to a user.

6. The method of claim 5, wherein the model information includes information selected from the group including: model brand, model type, model identification number, number of connections to other pieces of equipment and infrastructure, type of connections to other pieces of equipment and infrastructure, for the piece of equipment or infrastructure provides a fire detection functionality.

7. The method of claim 1, wherein the method includes receiving connection information about the piece of equipment or infrastructure and merging the connection information with the identifier, the location information, and the visual view data to provide the connection information to a user to enable the user to see how the piece of equipment or infrastructure is connected to other pieces of equipment or infrastructure within the facility.

8. The method of claim 7, wherein the connection information includes identification information for one or more connected other pieces of equipment or infrastructure.

9. The method of claim 7, wherein the connection information includes information selected from the group including: location information, functionality information, model information, connection information, status information, service history, usage history, for one or more connected other pieces of equipment or infrastructure.

10. A computing device, comprising:
a memory; and
a processor configured to execute executable instructions stored in the memory to:
receive an identifier associated with a piece of equipment or infrastructure within a facility;
receive location information associated with the location of the piece of equipment or infrastructure within the facility;
receive visual view data to produce a visual view of an area of the facility; and
merge the identifier, the location information, and the visual view data to produce a visual view on a user interface of the computing device to communicate the location of the piece of equipment or infrastructure to a user of the computing device.

11. The computing device of claim 10, wherein the instructions include instructions to receive status information about the piece of equipment or infrastructure and merge the status information with the identifier, the location information, and the visual view data to provide the status information to a user to enable the user to see the status of the piece of equipment or infrastructure.

12. The computing device of claim 11, wherein the status information includes information selected from the group including: an alarm status, a warning status, a failure status, a replacement status, a service request status, for the piece of equipment or infrastructure provides a fire detection functionality.

13. The computing device of claim 10, wherein the instructions include instructions to receive user device location information that indicates the location of a user device within the facility and to merge the user device location information with the identifier, the location information, and the visual view data to provide the user device location information to a user to enable the user to see their location relative to the piece of equipment or infrastructure.

14. The computing device of claim 13, wherein the instructions include instructions to calculate a route from the user device location to the location of the piece of equipment or infrastructure and providing a visual view of the route to a user.

15. A system, comprising:
a piece of equipment or infrastructure within a facility; and
a user device carried by a user within the facility, wherein at least one of the piece of equipment or infrastructure or the user device includes at least one of:
a first data store having an identifier associated with the piece of equipment or infrastructure;
a second data store having location information associated with the location of the piece of equipment or infrastructure within the facility;
a third data store having visual view data to produce a visual view of an area of the facility on a user device; and
a processor to execute instructions stored in memory to:
merge the identifier, the location information, and the visual view data to produce a visual view on a user interface of the computing device to communicate the location of the piece of equipment or infrastructure to a user of the computing device.

16. The system of claim 15, wherein the piece of equipment or infrastructure includes one or more sensors that provide data about the status of the piece of equipment or infrastructure or the status of the location in which the piece of equipment or infrastructure is located.

17. The system of claim 15, wherein the system further includes a gateway device that communicates information from the piece of equipment or infrastructure within the facility to the user device.

18. The system of claim 17, wherein the gateway device includes at least one of:
a first data store having an identifier associated with the piece of equipment or infrastructure;
a second data store having location information associated with the location of the piece of equipment or infrastructure within the facility;
a third data store having visual view data to produce a visual view of an area of the facility on a user device; and
a processor to execute instructions stored in memory to:
merge the identifier, the location information, and the visual view data to produce a visual view on a user interface of the computing device to communicate the location of the piece of equipment or infrastructure to a user of the computing device.

19. The system of claim 17, wherein the gateway device communicates the information indirectly to the user device via a network connection through a network device.

20. The system of claim 19, wherein the gateway device includes at least one of:
a first data store having an identifier associated with the piece of equipment or infrastructure;
a second data store having location information associated with the location of the piece of equipment or infrastructure within the facility;
a third data store having visual view data to produce a visual view of an area of the facility on a user device; and
a processor to execute instructions stored in memory to:
merge the identifier, the location information, and the visual view data to produce a visual view on a user interface of a computing device to communicate the location of the piece of equipment or infrastructure to a user of the computing device.
